(19) United States
(12) Patent Application Publication
(10) Pub. No.: US 2023/0047554 A1
(43) Pub. Date: Feb. 16, 2023

(54) Voice Control System for Recreational Vehicles

(71) Applicant: Winegard Company, Burlington, IA (US)

(72) Inventor: Lance Todd Beck, Burlington, IA (US)

(21) Appl. No.: 17/820,124

(22) Filed: Aug. 16, 2022

Related U.S. Application Data
(60) Provisional application No. 63/233,520, filed on Aug. 16, 2021.

(51) Int. Cl. B60W 50/12; B60W 40/09; G10L 15/22

(52) U.S. Cl. CPC B60W 50/12; B60W 40/09; G10L 15/22; B60W 2540/21; B60W 2554/4041; G10L 2015/223

(57) ABSTRACT

A voice control system for recreational vehicles controls safe operation of deployable components of the RV, such as an antenna, awning or room extension. A voice recognition system is employed to interpret voice commands and control operation of the deployable components in response. A control system monitors the status of the RV and its components to detect unsafe conditions relating to operation of the deployable components. For example, this can be done via a wired or wireless network of sensors detecting the state of the RV and its deployable components. The control system can also monitor the status of the RV via the data bus built into the RV. If an unsafe condition is detected, the safety manager of the control system triggers a warning or activates a predetermined interlock to prevent unsafe operation of the RV and its deployable components.

### RELATED APPLICATION

The present application is based on and claims priority to the Applicant's U.S. Provisional Patent Application 63/233,520, entitled “Voice Control System for an Antenna on a Recreational Vehicle,” filed on Aug. 16, 2021.

### BACKGROUND OF THE INVENTION

Field of the Invention. The present invention relates generally to the field of user control systems for recreational vehicles. More specifically, the present invention discloses a voice control system for recreational vehicles that enables voice control of the antenna, entertainment system and other devices, and also provides warnings or interlocks to prevent unsafe use of the antenna or other deployable components of the recreational vehicle.

Statement of the Problem. A number of voice control system have developed in the past for controlling operation of home entertainment systems, televisions, cable boxes, music systems and the like. For example, Xfinity offers a voice-activated remote control for its cable boxes. Amazon and Roku offer voice-activated remote controls for internet-based streaming devices that can interface to televisions and home entertainment systems. More generally, the Amazon Alexa and Google Android systems can be implemented on any number of devices (e.g., smart speakers and automobiles) to allow a user to control devices by voice commands.

This voice-control technology has also been extended to control deployment and operation of mobile antennas and other devices, such as are commonly used on recreational vehicles, mobile homes, trailers and the like. For the purposes of this disclosure, the term “recreational vehicle” or “RV” should be broadly construed to encompass all such vehicles. Similarly, the term “antenna” should be broadly construed to include any type of antenna that can be transported and deployed on a recreational vehicle.

Many mobile antennas can be moved between a stowed state while the vehicle is moving, and a deployed state when the vehicle has stopped and the antenna is in use. In addition, many mobile antennas are directional. In this case, the user may adjust the elevation or azimuth of the antenna to maximize the signal received from a desired signal source (e.g., a specific television station or satellite antenna). The prior art includes examples of remote control systems that enable a user to control the deployment and operation of a directional antenna. The prior art in this field also includes voice-actuated remote control systems for use in vehicles, including control of entertainment systems in a vehicle.

A separate, but related issue involves the use of warning systems or interlock systems to prevent unsafe operation of a vehicle or related devices. For example, vehicles typically include a warning light or audible alarm indicating that a door is open or that an occupant's seat belt is unfastened. Many recreational vehicles also include warning or interlock systems to detect if a door is open, or if an awning or room extension has not been retracted when the vehicle is started.

However, existing voice control systems for an antenna on a recreational vehicle do not integrate with the vehicle hardware or control system to provide warnings or interlock functions in the event of unsafe conditions. Therefore, a need exists for a voice control system for an antenna that incorporates these warnings or interlock functions to ensure safe operation of the recreational vehicle and its deployable components.

Solution to the Problem. The present invention addresses this shortcoming in the prior art by providing a voice control system for deployable components (e.g., room extension, awning, or antenna) of a recreational vehicle that also includes integration with components of the RV to detect unsafe conditions and provide appropriate warnings or interlock functions.

### SUMMARY OF THE INVENTION

This invention provides a voice control system for recreational vehicles having deployable components, such as an antenna, awning or room extension. A voice command system with voice recognition functionality is employed to interpret voice commands and control operation of the deployable components in response. A safety supervisor monitors the status of the RV and its components to detect unsafe conditions relating to operation of the deployable components. For example, this can be done via a wired or wireless network of sensors detecting the state of the RV and its deployable components. The voice control system can also monitor the status of the RV via the data bus built into the RV. If an unsafe condition is detected, the safety supervisor of the voice control system triggers a warning or activates a predetermined interlock to prevent unsafe operation of the RV and its deployable components.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified diagram of a conventional recreational vehicle 20 equipped with an antenna 10 and other deployable components.

FIG. 2 is a simplified block diagram of the present system.

### DETAILED DESCRIPTION OF THE INVENTION

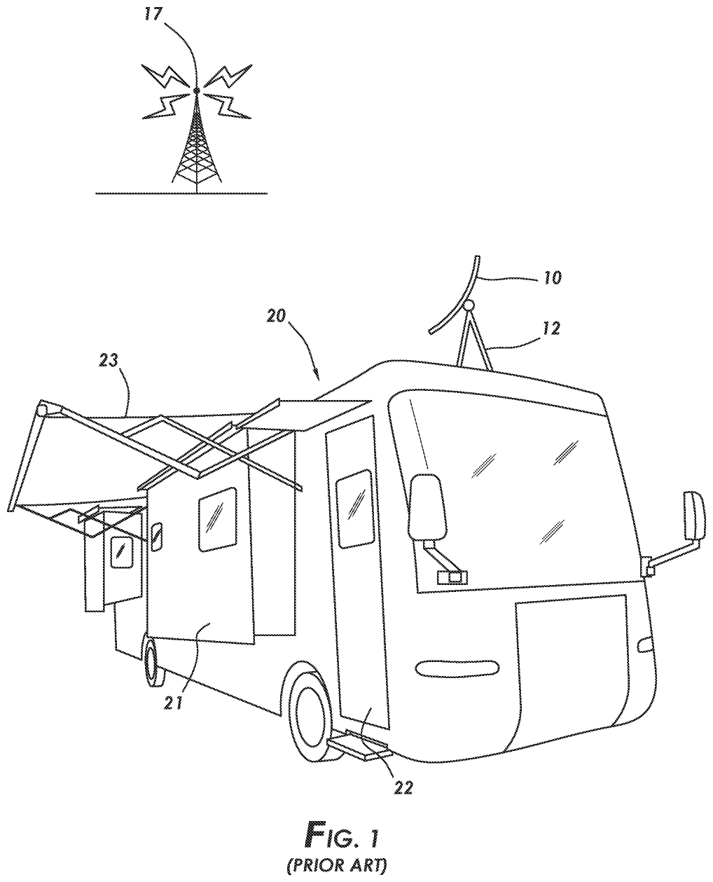

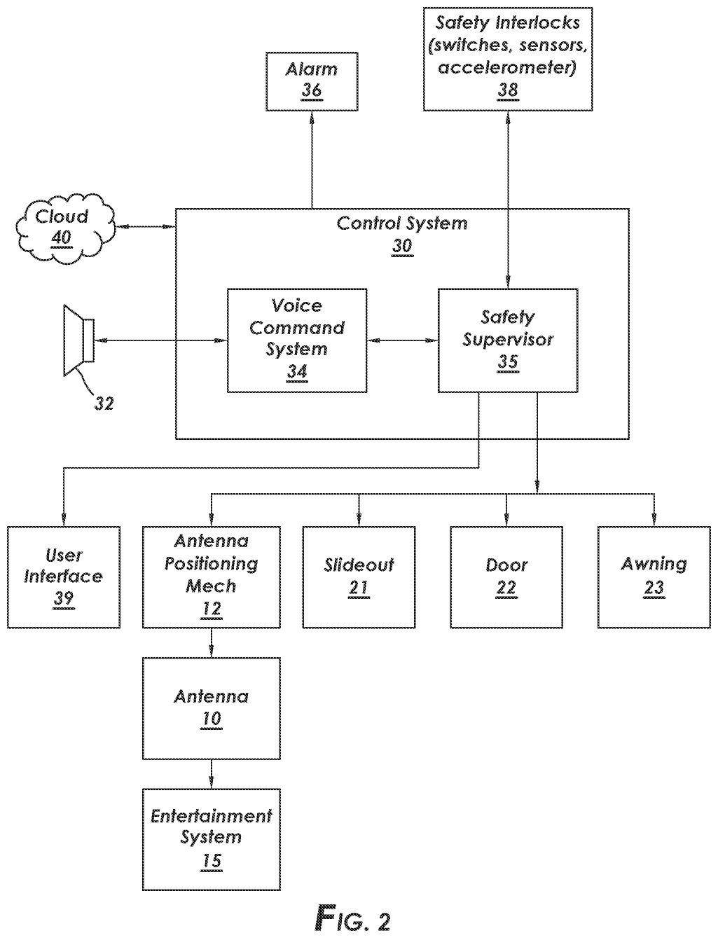

FIG. 1 shows a typical recreational vehicle (RV) 20 carrying an antenna 10. FIG. 2 is a simplified block diagram of one possible embodiment of the present invention. An antenna 10 is mounted to the RV 20 in a conventional manner to deliver received signals to an entertainment system 15 (e.g., television, wi-fi router, or music system) within the RV 20. An antenna deployment/positioning mechanism 12 is used to selectively move the antenna 10 between a stowed position and a deployed position. The antenna 10 is typically deployed only when the RV 20 is parked and is stowed while the RV is in motion. If the antenna 10 is directional in nature, this deployment/positioning mechanism 12 can also be used to adjust the position of the deployed antenna 10 in the elevational and azimuth directions to maximize the signal received from a desired external signal source 17 (e.g., a selected terrestrial TV transmitter or a satellite).

The RV 20 often includes a number of other deployable components, such as a sliding room extension 21, exterior door 22 or awning 23 that should be closed or stowed prior to moving the RV 20. Many RV's are equipped with safety interlock sensors 38 to detect the status of these deployable components and provide warnings for safety and to prevent damage to the RV 20. Other sensors can be used to detect motion or imminent motion of the RV. For example, an audible or visible alarm 36 can be triggered if the vehicle's engine is turned on when an exterior door 22 is ajar or if the sliding room extension 21 has not been retracted. These sensors 38 are typically connected to the vehicle's control system via a standard communications protocol over a conventional data bus.

As shown in FIG. 2, the present invention includes a control system (e.g., a computer processor) 30 that monitors and controls operation of the deployable components 21-23, including the antenna deployment/positioning mechanism 12 and also monitors the operational status of the RV 20 via the safety interlock sensors 38. As previously mentioned, these sensors 38 can be pre-installed in the RV 20 and monitored over the RV's data bus. In addition, sensors 38 can be custom installed to meet the specific requirements of a particular RV 20. For example, motion or imminent motion of the RV 20 can be sensed via a global positioning system (GPS) unit, an accelerometer, gyroscope, or by monitoring the RV's data bus. For example, operation of the RV's engine and speed of the wheels can be detected by monitoring the RV's data bus.

These sensors 38 can be implemented by smart sensors connected to the control system 30 over a wireless local area network (LAN) (e.g., a wi-fi, LoRa, Zigbee or Bluetooth network) or by wired connections (e.g., automotive UART, RS232, RS422, RS485, ethernet, 1-Wire, RV-C, or CAN bus). Alternatively, these sensors can be implemented by conventional switches, relays, pressure sensors or proximity sensors that detect a predetermined physical or electrical state to monitor the status of components of the RV 20. For example, a switch can be used to detect whether an awning 23 is extended or retracted.

As also shown in FIG. 2, the control system 30 includes a voice command system 34 with a microphone or speaker 32 for receiving voice commands from a user. The voice command system 34 interprets and recognizes a predetermined set of voice commands for controlling operation of the antenna 10, antenna deployment/positioning mechanism 12 or entertainment system 15 (e.g., power on/off, channel selection or volume adjustment). Optionally, the voice command system 34 can also be integrated into the RV's control system to recognize a set of voice commands relating to features of the RV 20 for other deployable components, such as retracting or extending an awning 23 or room extension 21. For example, this voice recognition functionality can be provided by computer software executed by a local processor or a remote server over the internet 40.

The control system 30 also includes a safety supervisor 35 that monitors and controls all of the safety functions of the present system based on the inputs/specifications in the present system. For example, the safety supervisor can receive inputs from the sensors 38 and vehicle data bus, as well as the voice command system 34 and other user interface 39 inputs. Communications between the voice command system 34 and the control system 30 can be done via an RV-C link, which a two-way serial hardwired communications protocol. This can also be employed to communicate with the devices to be actuated (e.g., the slide-out 21, awning 23 and antenna 10). Alternatively, wireless communications could be used, as well as wired analog or digital communications. The safety interlocks could also employ any of these communications protocols. The present invention, including the speaker 32, voice command system 34, controller 30 and safety interlock sensors 38, could be housed in the same enclosure, such as a ceiling-mounted RV unit. These commands are then used by the control system 30 and its safety supervisor 35 to control the appropriate hardware for execution of the commands. For example, the control system 30 can be used to control operation of the deployable components (e.g., the antenna 10 and the antenna deployment/positioning mechanism 12) and the entertainment system 15. Appropriate hardware in the RV 20 can also be controlled to perform commands relating to features of the RV 20.

As previously discussed, the control system 30 receives inputs from the safety interlock sensors 38 as well as the voice command system 34 and user interfaces 39 (e.g., a smart phone app). This enables the safety supervisor 35 of the control system 30 to continually monitor the status of the RV 20 (e.g., motor on/off, RV moving, status of any room extension 21, doors 22 and awning 23) and detect unsafe or incompatible conditions before executing voice commands. For example, the safety supervisor 35 can be programmed to activate audible or visible warnings 36 (such as display warnings, lights, or audible alarms) if predetermined safety conditions are detected. Audible warnings can be computer-generated voice messages selected by the control system 30 and played on a smart speaker 32.

In addition, the safety supervisor 35 of the control system 30 can be programmed to provide interlock functionality to prevent execution of predetermined voice commands under predetermined conditions—particularly voice commands that would result in unsafe conditions. For example, the safety supervisor 35 could prevent deployment of the deployable components (e.g., antenna 10) if the motion sensor detects the RV 20 is moving or movement is imminent. This may be accompanied by an explanatory warning to the user. Similarly, the safety supervisor 35 can trigger a warning 36 if the antenna 10 is still deployed when the RV 20 starts moving or movement is imminent. The control system 30 could also automatically retract the antenna 10 in this case.

It should be noted that the present system allows the use of multiple safety interlocks 38 to be programmed to be used by the safety supervisor 35. For example, an accelerometer could be used as a single interlock sensor 38 to detect motion of the RV 20. However, multiple safety interlocks could be provided for redundancy. Conventional safety interlocks built into the control system of the RV could be combined with one or more additional safety interlocks provided with the present system. For example, many RV's require continual activation of a deadman's switch to open the RV's slide-out 21 (i.e., the operator must continue to press the deadman's switch during opening or else the slide-out 21 stops). This could be combined with an accelerometer to make sure that the vehicle 20 is not in motion. Similarly, the vehicle ignition switch and brake engagement can be monitored to further ensure that the RV 20 is not in motion when the slide-out 21 is opened. The ignition switch can also be monitored as an indicator that the vehicle 20 will be going in motion soon and give appropriate warnings regarding the need to need to stow the antenna 10 and retract the slide-out 21.

After the RV 20 has been parked and the antenna 10 deployed, the control system 30 can also be programmed to direct the antenna to search for available signal sources 17 and store data regarding their locations relative to the RV 20. Alternatively, the controller can determine the location of the RV 20 from a GPS device and download data over the internet regarding the location and identity of available signal sources 17. This information can be displayed to enable the user to select desired programming. The control system 30 can then automatically position the antenna 10 to maximize the received signal strength from a selected signal source 17.

Optionally, the control system 30 can interface to the data bus of the RV 20. This can be used both to monitor the RV's pre-existing sensors to detect the operational status of the RV 20, and optionally, to provide warning or interlock functions via pre-existing components of the RV 20. For example, pre-existing sensors in the RV 20 can be employed to detect the operational status of the RV, (e.g., whether the RV motor is running, or the sliding room extension 21 has not been retracted, or a door 22 is open, or an awning 23 is extended). The status of the RV's ignition system can also be monitored via the data bus. These status indications can then be used by the control system 30 to recognized unsafe conditions requiring activation of a warning or interlock function by the control system 30, as previously discussed.

As previously discussed, the voice command system 34 can be implemented locally as an offline, stand-alone system. Alternatively, the voice command system can be implemented online as an internet-based system. For example, the present system can be implemented as an “internet of things” (or “IoT”) system with smart components communicating over a wired or wireless LAN with internet 40 access. A smart speaker, such as the Alexa or Amazon Echo device marketed by Amazon, can serve as the hub. The smart speaker contains both a speaker and microphone to provides a voice interface for commands and responses. The smart speaker is typically connected via the internet 40 to a remote server hosting voice recognition software. Alexa also includes the “Alexa Skills Kit”, which is a collection of application programming interfaces (API) and software tools that enable a developer to add skills to Alexa. All of the code runs in the cloud 40. Optionally, all of the functionality described above with regard to the control system 30 can be implemented as skills for Alexa.

Alexa can be programmed to recognize unique “wake words” for commands relating to RV controls, the antenna/entertainment system, and basic Alexa queries and commands. The user can then issue voice commands to the Alexa device. For example, voice commands can be given to turn the entertainment system on or off, deploy or stow the antenna, adjust the volume of the entertainment system, control the position of the antenna, select a desire signal source or channel, etc. This embodiment of the present invention has the advantage of enabling more complete integration of the capabilities of the system components. For example, Alexa can control the entertainment system 15 to make automatic adjustments to its audio volume level to compensate for changes in the ambient noise level in the RV 20 as sensed by the microphone or based on the speed of the RV 20 as sensed by an accelerometer.

In addition, voice commands can be authorized to control certain RV functions (e.g., control the awning or sliding room extension) if the controller 30 is interfaced to the RV data bus. However, security required for such RV functions should be heightened for safety reasons and to prevent accidental activation of these RV features.

The speaker of an Alexa device can be used to complete the user interface by confirming receipt and completion of voice commands, reporting the status of the antenna, entertainment system and RV, and responding to general queries. Optionally, the present system may include a visual display (e.g., via a smart phone app, tablet, computer display, or the vehicle display screen) as part of the user interface 39. For example, the display can be used to show the user a list or map of available signal sources, a programming guide, or signal strength information.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A voice control system for use with a recreational vehicle having deployable components and sensors detecting the operational status of the recreational vehicle including movement or imminent movement of the recreational vehicle; said voice control system comprising:
a microphone receiving voice commands from a user;
a voice command system interpreting the voice commands received by the microphone; and
a safety supervisor receiving inputs from the sensors and voice command system; said safety supervisor controlling operation of the deployable components in response to the voice commands, including an interlock function preventing deployment of the deployable components under predetermined conditions detected by the sensors indicating movement or imminent movement of the recreational vehicle.

2. The voice control system of claim 1 wherein the deployable components comprise an antenna with an antenna deployment/positioning mechanism mounted to the recreational vehicle supporting the antenna.

3. The voice control system of claim 1 wherein the deployable components comprise a retractable awning.

4. The voice control system of claim 1 wherein the deployable components comprise a room extension.

5. The voice control system of claim 1 further comprising a warning triggered by the safety supervisor under predetermined conditions detected by the sensors indicating movement or imminent movement of the recreational vehicle if the deployable components are deployed.

6. The voice control system of claim 1 further comprising a warning triggered by the safety supervisor under predetermined conditions detected by the sensors indicating movement or imminent movement of the recreational vehicle if the user commands deployment of the deployable components.

7. The voice control system of claim 1 wherein the sensors comprise a global positioning system (GPS) unit.

8. The voice control system of claim 1 wherein the sensors comprise an accelerometer.

9. The voice control system of claim 1 further comprising a bus communicating signals indicating the operational status of the recreational vehicle including movement or imminent movement of the recreational vehicle, and wherein the safety supervisor monitors the bus to determine the operational status of the recreational vehicle.

10. The voice control system of claim 9 wherein the bus communicates signals indicating whether the motor of the recreational vehicle is running.

11. A voice control system for use with a recreational vehicle having deployable components and a bus communicating signals indicating the operational status of the recreational vehicle including movement or imminent movement of the recreational vehicle; said voice control system comprising:
a microphone receiving voice commands from a user;
a voice command system interpreting the voice commands received by the microphone; and
a safety supervisor monitoring the bus to determine the operational status of the recreational vehicle and receiving inputs from the voice command system; said safety supervisor controlling operation of the deployable components in response to the voice commands, including an interlock function preventing deployment of the deployable components under predetermined conditions detected by the sensors indicating movement or imminent movement of the recreational vehicle.

12. The voice control system of claim 11 wherein the deployable components comprise an antenna with an antenna deployment/positioning mechanism mounted to the recreational vehicle supporting the antenna.

13. The voice control system of claim 11 wherein the deployable components comprise a retractable awning.

14. The voice control system of claim 11 wherein the deployable components comprise a room extension.

15. The voice control system of claim 11 further comprising a warning triggered by the safety supervisor under predetermined conditions detected by the sensors indicating movement or imminent movement of the recreational vehicle if the deployable components are deployed.

16. The voice control system of claim 11 further comprising a warning triggered by the safety supervisor under predetermined conditions detected by the sensors indicating movement or imminent movement of the recreational vehicle if the user commands deployment of the deployable components.

17. The voice control system of claim 11 further comprising a bus communicating signals indicating the operational status of the recreational vehicle including movement or imminent movement of the recreational vehicle, and wherein the safety supervisor monitors the bus to determine the operational status of the recreational vehicle.

18. A voice control system for use with a recreational vehicle having an antenna, an antenna deployment/positioning mechanism mounted to the recreational vehicle and supporting the antenna, an entertainment system receiving signals from the antenna, and sensors detecting the operational status of the recreational vehicle including movement or imminent movement of the recreational vehicle; said voice control system comprising:
a microphone receiving voice commands from a user;
a voice command system interpreting the voice commands received by the microphone; and
a safety supervisor receiving inputs from the sensors and voice command system; said safety supervisor controlling operation of the antenna deployment/positioning mechanism and entertainment system in response to the voice commands, including an interlock function preventing deployment of the antenna by the antenna deployment/positioning mechanism under predetermined conditions detected by the sensors indicating movement or imminent movement of the recreational vehicle.
